(19) United States
(12) Patent Application Publication
(10) Pub. No.: US 2007/0018977 A1
(43) Pub. Date: Jan. 25, 2007

(54) Method and apparatus for generating a depth map

(76) Inventors: Wolfgang Niem, Hildesheim (DE); Stefan Mueller-Schneiders, Hildesheim (DE); Hartmut Loos, Hildesheim (DE); Thomas Jaeger, Gettorf (DE)

Correspondence Address: STRIKER, STRIKER & STENBY, 103 EAST NECK ROAD, HUNTINGTON, NY, 11743, US

(21) Appl. No.: 11/451,021

(22) Filed: Jun. 12, 2006

(30) Foreign Application Priority Data
Jul. 25, 2005 (DE) 10 2005 034 597.2

(51) Int. Cl. G06T 15/40

(52) U.S. Cl. 345/422

(57) ABSTRACT

In a method and an apparatus for generating a depth map of a scene to be recorded with a video camera, the scene is recorded at a plurality of focus settings differing from one another, and the focus setting proceeds through the depth range of the scene in increments; the image components recorded in focus at a given focus setting are assigned the depth corresponding to that focus setting, creating a first depth map; the scene is recorded a plurality of times, each at a different zoom setting, and from the geometric changes in image components, the depth of the respective image component is calculated, creating a second depth map; and from the two depth maps, a combined depth map is formed.

### CROSS-REFERENCE TO A RELATED APPLICATION

The invention described and claimed hereinbelow is also described in German Patent Application DE 102005034597.2 filed on Jul. 25, 2005 This German Patent Application, whose subject matter is incorporated here by reference, provides the basis for a claim of priority of invention under 35 U.S.C. 119(a)-(d).

### BACKGROUND OF THE INVENTION

The present invention relates to a method and an apparatus for generating a depth map of a scene to be recorded with a video camera.

In video monitoring systems with fixedly installed cameras, image processing algorithms are used for automatically evaluated video sequences. In the process, moving objects are distinguished from the unmoving background of the scene and are followed over time. If relevant movements occur, alarms are tripped. For this purpose, the methods used usually evaluate the differences between the current camera image and a so-called reference image for a scene. The generation of a reference image for a scene is described for instance by K. Toyama, J. Krumm, B. Brumitt, and B. Meyers, in “Wallflower: Principles and Practice of Background Maintenance”, ICCV 1999, Corfu, Greece.

Monitoring moving objects is relatively simple, as long as the moving object is always moving between the camera and the background of the scene. However, if the scene is made up not only of a background but also of objects located closer to the camera, these objects can cover the moving objects that are to be monitored. To overcome these problems, it is known to store the background of the scene in the form of a depth map or three-dimensional model.

One method for generating a depth map has been disclosed by U.S. Pat. No. 6,128,071. In it, the scene is recorded at a plurality of different focus settings. The various image components that are reproduced in focus on the image plane are then assigned a depth that is defined by the focus setting. However, the lack of an infinite depth of field and mistakes in evaluating the image components make assigning the depth to the image components problematic.

Another method, known for instance from G. Ma and S. Olsen, “Depth from zooming”, J. Opt. Soc. Am. A., Vol. 7, No. 10, pp. 1883-1890, 1990, is based on traversing through the focal range of a zoom lens and evaluating the resultant motions of image components within the image. In this method as well, possibilities of mistakes exist, for instance because of mistakes in following the image components that move because of the change in focal length.

### SUMMARY OF THE INVENTION

It is therefore an object of the present invention to provide a method and an apparatus for generating a depth map, which is a further improvement of the existing methods and apparatus of this type.

More particularly, it is an object of the present invention to generate a depth map that is as exact as possible.

This object is attained according to the invention in that the scene is recorded in a plurality of different focus settings, the focus setting proceeding incrementally through the depth range of the scene; and that the image components recorded in focus at a given focus setting are assigned the depth which corresponds to that focus setting, so that a first depth map is created; that the scene is recorded a plurality of times, each with a different zoom setting, and from the geometric changes in image components, the depth of the respective image component is calculated, so that a second depth map is created; and that from the two depth maps, a combined depth map is formed.

Besides for generating a background of a scene for monitoring tasks, the method of the invention can also be employed for other purposes, especially those in which a static background map or a 3D model is generated. Since a scene in motion is not being recorded, there is enough time available for performing the method of the invention. To obtain the most unambiguous possible results in driving the first depth map from the change in the focus setting, a large aperture should be selected, so that the depth of field will be as small as possible. However, in traversing the zoom range, an adequate depth of field should be assured, for instance by means of a small aperture setting.

An improvement in the combined depth map is possible, in a refinement of the invention, because locally corresponding image components of the first and second depth maps with similar depths are assigned a high confidence level, while locally corresponding image components with major deviations between the first and second depth maps are assigned a lower confidence level; image components with a high confidence level are incorporated directly into the combined depth map, and image components with a lower confidence level are incorporated into the combined depth map taking the depth of adjacent image components with a high confidence level into account.

A further improvement in the outcome can be attained by providing that the recordings, the calculation of the first and second depth maps, and the combination to make a combined depth map are performed repeatedly, and the image components of the resultant combined depth maps are averaged. It is preferably provided that the averaging is done with an IIR filter.

Assigning different confidence levels to the image components can advantageously be taken into account in a refinement by providing that a coefficient of the IIR filter is dependent on the agreement of the image components of the first depth map with those of the second depth map, such that compared to the preceding averaged image components, image components of the respective newly combined depth map are assessed more highly if high agreement exists than if low agreement exists.

The apparatus of the invention is characterized by means for recording the scene at a plurality of different focus settings, with the focus setting proceeding incrementally through the depth range of the scene; by means, which assign to the image components recorded in focus at a given focus setting the depth which corresponds to that focus setting, so that a first depth map is created; by means for repeatedly recording the scene, each at a different zoom setting; by means for calculating the depth of the respective image component from the geometric changes in image components, so that a second depth map is created; and by means for forming a combined depth map from the two depth maps.

Advantageous refinements of and improvements to the apparatus of the invention are recited in further dependent claims.

Exemplary embodiments of the invention are shown in the drawings and described in further detail in the ensuing description.

### BRIEF DESCRIPTION OF THE DRAWINGS

FIG. 1 is a block circuit diagram of an apparatus according to the invention; and

FIG. 2 is a flow chart for explaining an exemplary embodiment of the method of the invention.

### DESCRIPTION OF THE PREFERRED EMBODIMENTS

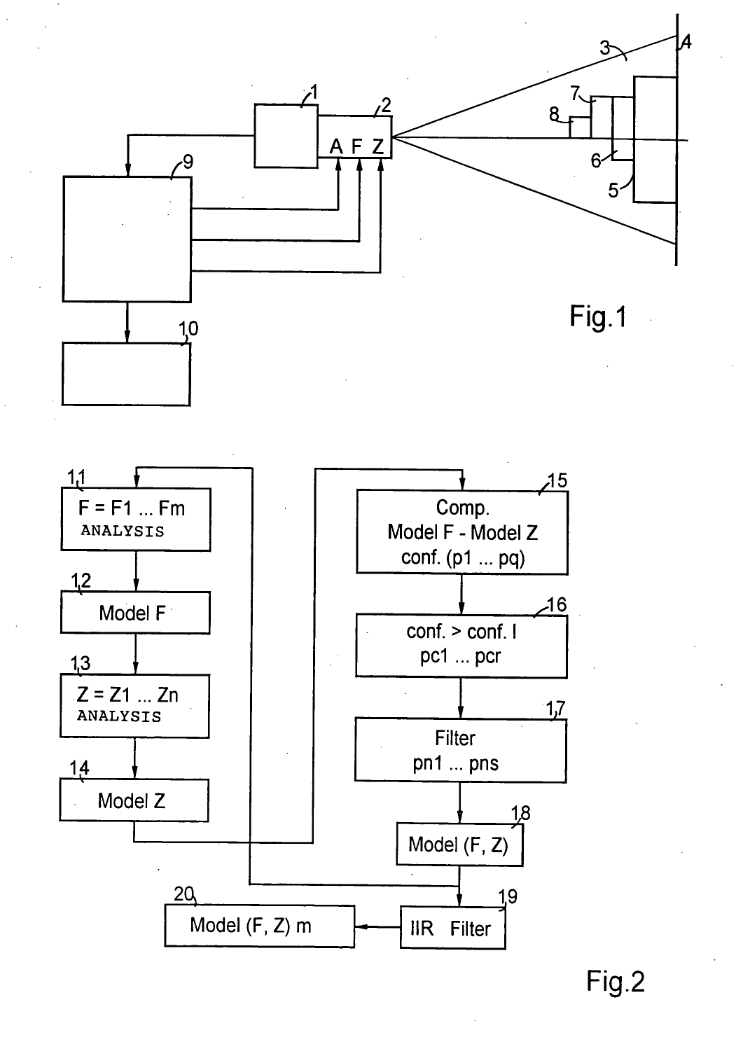

The apparatus shown in FIG. 1 comprises a video camera 1, known per se, with a zoom lens 2, which is aimed at a scene 3 that is made up of a background plane 4 and of objects 5, 6, 7, 8 rising above this background.

For signal processing and for complete sequence control, a computer 9 is provided, which controls final control elements, not individually shown, of the zoom lens 2, mainly the focus setting F, the zoom setting Z, and the aperture A. A memory 10 for storing the completed depth map is connected to the computer 9. Further components, such as monitors and alarm devices, that may also serve to put the depth map to use, particularly for room monitoring, are not shown for the sake of simplicity.

In the method shown in FIG. 2, the focus setting F is first varied in step 11 between two limit values F1 and Fm; for each focus setting, the recorded image is analyzed such that the image components that are in focus or sharply reproduced at one focus setting are stored in memory as belonging to the particular plane of focus (hereinafter also called depth). Suitable image components are for instance groups of pixels, which are suitable for detecting the sharp focus, such as groups of pixels in which a sufficiently high gradient can be detected in a sharp reproduction of an edge. In step 12, the depth map or model F is then stored in memory.

In step 13, images are then recorded for zoom settings Z=Z1−Zn. In the analysis of the motions of the image components during the variation among the various zoom settings, the respective depth of image components is calculated, and the edges are selected such that an image processing system recognizes them again after a motion. The resultant depth maps are stored in memory as a model Z in step 14.

In method step 15, the locally corresponding image components of the two models are compared. Image components with similar depth indications are given a high confidence level, while those in which the depth indications deviate sharply from another are assigned a low confidence level. Once confidence levels p1 through pq are calculated for each image component, these confidence levels are compared in step 16 with a threshold value conf.1, so that after method step 16, the depth for image components pc1 through pcr are definite, with a high confidence level.

In a filter 17 with which it is essentially analyses of the neighborhood of image components with high confidence level that are performed, depth values for image components pn1 through pns are calculated, whereupon in step 18, the image components pc1 through pcr and pn1 through pns are stored in memory as a model (F, Z). For increasing the resolution, method steps 11 through 18 are repeated multiple times, and the resultant depth maps are sent to an IIR filter 19, which processes the various averaged depth values of the image components as follows:

Tm=α•Tnew+(1−α)•Told. The factor α is selected in each case in accordance with the confidence level assigned in step 15. In step 20, the model (F, Z)m ascertained by the IIR filter 19 is stored in memory.

It will be understood that each of the elements described above, or two or more together, may also find a useful application in other types of methods and constructions differing from the types described above.

While the invention has been illustrated and described as embodied in a method and apparatus for generating a depth map, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method for generating a depth map of a scene to be recorded with a video camera, comprising the steps of recording the scene in a plurality of different focus settings, with the focus settings preceding incrementally through a depth range of the scene; assigning image components recorded in focus at a given focus setting, a depth which corresponds to that focus setting, so that a first depth map is created; recording the scene a plurality of times each with a different zoom setting; and from geometric changes in image components calculating a depth of the respective image component, so that a second depth map is created; and forming a combined depth map from said first and second depth maps.

2. A method as defined in claim 1; and further comprising assigning a high confidence level to locally corresponding image components of the first and second depth maps with similar depths, while assigning a lower confidence level to locally corresponding image components with major deviations between said first and second depth maps; incorporating image components with the high confidence level directly into the combined depth map, while incorporating image components with the lower confidence level into the combined depth map taking a depth of adjacent image components with the high confidence level into account.

3. A method as defined in claim 1; and further comprising performing repeatedly said recording, said calculation of said first and second depth maps, and said combination to make the combined depth map; and averaging the image components of resultant combined depth maps.

4. A method as defined in claim 3; wherein said averaging including an averaging performed with an IIR filter.

5. A method as defined in claim 4; and further comprising providing a coefficient of the IIR filter such that it is dependent on an agreement of the image components of said first depth map with the image component of said second depth map, such that compared to preceding average image components, image components of a respective newly combined depth map are assessed more highly if a high agreement exists than if a low agreement exists.

6. An apparatus for generating a depth map of a scene to be recorded by a video camera, comprising means for recording a scene at a plurality of different focus settings, with the focus settings proceeding incrementally through a depth range of the scene; means for assigning to image components recorded in focus at a different focus setting, a depth which corresponds to that focus setting, so that a first depth map is created; means for repeatedly recording the scene, each at a different zoom setting; means for calculating a depth of a respective image component from geometrical changes in image components, so that a second depth map is created; and means for forming a combined depth map from said first and second depth maps.

7. An apparatus as defined in claim 6; and further comprising means for assigning a high confidence level to local corresponding image components of said first and second depth maps that has similar depths and a low confidence level to locally corresponding image components with major deviations between said first and second depth maps, in which image components with the high confidence level are incorporated directly into the combined depth map while image components with the low confidence level are incorporated into the combine depth map taking a depth of adjacent image components with the high confidence level into account.

8. An apparatus as defined in claim 6; and further comprising means for repeatedly taking the recordings, calculating said first and second depth maps and combining them in the combined depth map, and for averaging the image components of the combined depth maps thus created.

9. An apparatus as defined in claim 8; and further comprising an IIR filter for the averaging of the image components of the combined depth maps thus created.

10. An apparatus as defined in claim 9, wherein said IIR filter has a coefficient which is dependent on an agreement of the image components of the first depth map with the image components of the second depth map, such that compared to preceding averaged image components, image components of a respective newly combined depth map are assessed more highly if a high agreement resists than when a low agreement exists.
